(19) United States
(12) Patent Application Publication
(10) Pub. No.: US 2025/0198523 A1
(43) Pub. Date: Jun. 19, 2025

(54) CHECK VALVE

(71) Applicant: HL MANDO CORPORATION, Gyeonggi-do (KR)

(72) Inventor: Kiwon KANG, Gyeonggi-do (KR)

(21) Appl. No.: 18/847,623

(22) PCT Filed: Mar. 14, 2023
(86) PCT No.: PCT/KR2023/003385

§ 371 Date: Sep. 16, 2024

(30) Foreign Application Priority Data
Mar. 16, 2022 (KR) 10-2022-0032499

(51) Int. Cl. F16K 15/02; B60T 13/14; B60T 15/36; F16K 27/02

(52) U.S. Cl. CPC F16K 15/025; B60T 13/14; B60T 15/36; F16K 27/0209

(57) ABSTRACT

A check valve is disclosed. The check valve according to the present embodiment may comprise: a sheet that is press-fitted into the inner diameter of a bore; a filter which is seated on the upper side of the sheet and through which a fluid passes; a plunger disposed below the sheet to open and close the sheet; a seal installed to surround the plunger; a spring which provides a restoring force to the plunger; and a housing which is assembled to the sheet and guides the vertical movement of the plunger.

### TECHNICAL FIELD

The present disclosure relates to a check valve provided in a hydraulic flow passage of an electronically controlled brake system.

### BACKGROUND ART

In general, a brake system is intended to effectively prevent a slip phenomenon of a wheel that may occur during braking, sudden unintended acceleration, or sudden acceleration of a vehicle, and is installed in a modulator block including a plurality of solenoid valves that controls braking hydraulic pressure transmitted from a master cylinder to a wheel cylinder and a flow passage in which a plurality of check valves that prevents a reverse flow of oil forms a hydraulic circuit, to control the braking hydraulic pressure. Recently, an electronic brake system has been used in which a hydraulic pressure supply device is provided to supply pressure to the wheel cylinder by receiving a driver's braking intention as an electric signal from a pedal displacement sensor that detects a displacement of a brake pedal when a driver presses the brake pedal.

The electronic brake system is configured to generate the braking pressure by operating a motor according to an effort of the brake pedal. In this case, the braking pressure is generated by converting rotational force of the motor into linear motion and pressurizing a piston. In the flow passage formed in the modulator block, a check valve is installed at the right time and place to control the flow of oil in one direction. For example, the check valve is installed in a flow passage connecting the pressure supply device and a reservoir, a flow passage connected to an inlet valve of each hydraulic circuit, etc.

### DISCLOSURE

### Technical Problem

An exemplary embodiment of the present disclosure is to provide a check valve that is mounted directly at a lower end of a reservoir.

An exemplary embodiment of the present disclosure is to provide a check valve that utilizes an inner shape of a bore formed in a block as a flow passage.

### Technical Solution

According to one aspect of the present disclosure, a check valve installed in a bore formed in a block and controlling a flow direction of a fluid supplied from a reservoir includes: a sheet that is press-fitted into an inner diameter of a bore; a filter that is seated on an upper side of the sheet and through which the fluid passes; a plunger that is disposed on a lower side of the sheet to open and close the sheet; a seal that is installed to surround the plunger; a spring that provides a restoring force to the plunger; and a housing that is assembled to the sheet and guides a vertical movement of the plunger.

The sheet may include: a large outer diameter portion that directly communicates with the reservoir; and a small outer diameter portion that has a diameter smaller than the large outer diameter portion.

The filter may be seated by contacting an inner diameter of the large outer diameter portion.

The small outer diameter portion may be coupled to an upper portion of the housing.

The plunger may include: an upper portion that contacts the sheet; a middle portion that seats the seal; a lower portion that supports a lower side of the seal; and a rod that penetrates through a lower portion of the housing.

The spring may be disposed between the lower portion of the plunger and the lower portion of the housing.

The lower portion of the housing may be formed with an opening so that the rod passes therethrough, and a guide part that is formed to surround an outer diameter of the rod and guides the rod.

The lower portion of the sheet may be provided with a first inclined surface inclined downward, and the upper portion of the plunger may be provided with a second inclined surface inclined to correspond to the first inclined surface.

When the plunger rises, the second inclined surface of the plunger may come into close contact with the first inclined surface of the sheet to block the flow of the fluid into the reservoir.

The upper portion of the plunger may be formed with a protrusion extending into an inside of the sheet.

The plunger may have a locking jaw formed below the lower portion.

The spring may be disposed between the lower portion of the plunger and the lower portion of the housing, and an inner diameter may be formed to be larger than an outer diameter of the locking jaw so that the upper portion is fitted into the locking jaw.

The lower portion of the housing may be formed with a guide part that is formed to surround an outer diameter of the rod and guide the rod, and the locking jaw may be formed to have a size of an outer diameter similar to that of the outer diameter of the guide part.

The sheet may be screwed to the housing.

The sheet may include: a large outer diameter portion that directly communicates with the reservoir; and a small outer diameter portion that has a diameter smaller than the large outer diameter portion, the small outer diameter portion may have a screw thread formed on an outer diameter, and an inner diameter of the upper portion of the housing may have a screw thread formed to engage the screw thread.

According to another aspect of the present disclosure, a check valve may include: a sheet that is installed in a bore formed in a block and in which a fluid flows from a reservoir; a housing that is assembled to a lower portion of the sheet; a filter that is seated on an upper portion of the sheet and through which the fluid passes; a plunger that is disposed on a lower side of the sheet to open and close the sheet; a seal that is installed to surround the plunger; and a spring that provides a restoring force to the plunger.

The fluid may pass through a grommet installed at an outlet of a reservoir that accommodates the fluid, pass through the filter, and then flow into the sheet.

When the fluid flows in from the reservoir, the plunger may be lowered to form a space between the lower portion of the sheet and the upper portion of the plunger.

The seal may be disposed to surround an outer diameter of the plunger and may seal between a lower surface of the sheet and an upper surface of the plunger.

The housing may include: a ring-shaped upper plate that is coupled to a lower end of the sheet; a lower plate that is spaced apart from the upper plate by a predetermined distance and has an opening formed therein; and a plurality of connecting rods that connects the upper plate and the lower plate.

### Advantageous Effects

Since a check valve according to an exemplary embodiment of the present disclosure is mounted directly on a lower end of a reservoir without a separate bore space, it is possible to minimize fluid resistance during passing through the check valve.

A check valve according to an exemplary embodiment of the present disclosure can be sealed without components such as a separate cap, and thus, can have a structure that does not require external sealing.

Since a check valve according to an exemplary embodiment of the present disclosure utilizes an inner shape of a bore as a flow passage, it is possible to maximize a fluid flow area.

### DESCRIPTION OF DRAWINGS

FIG. 1 is a perspective view of a check valve according to an exemplary embodiment of the present disclosure.

FIG. 2 is a cross-sectional view illustrating a state in which the check valve according to an exemplary embodiment of the present disclosure is installed.

FIG. 3 is an exploded perspective view of the check valve according to an exemplary embodiment of the present disclosure.

FIG. 4 is an exploded perspective view of the check valve according to an exemplary embodiment of the present disclosure viewed from a different direction from FIG. 3.

FIG. 5 is a cross-sectional view illustrating an example in which a radial flow passage is formed in a block in FIG. 2.

FIG. 6 is a cross-sectional view illustrating an example in which an axial flow passage is formed in a block in FIG. 2.

FIG. 7 is a cross-sectional view illustrating an example in which the check valve blocks a reflux in a state shown in FIG. 2.

### BEST MODE

Hereinafter, exemplary embodiments of the present disclosure will be described in detail with reference to the accompanying drawings. The following exemplary embodiments are provided by way of example so that those skilled in the art will be able to completely recognize the scope of the present disclosure. The present disclosure is not limited to exemplary embodiments to be described below, but may be implemented in other forms. In order to clearly describe the present disclosure, parts that are not related to the description are omitted from the drawings, and in the drawings, the width, length, thickness, etc., of components may be expressed exaggeratedly for convenience. Same reference numerals denote same constituent elements throughout the specification.

Hereinafter, an axial direction means a direction parallel to a longitudinal direction of a check valve, and a radial direction means a direction perpendicular to the axial direction.

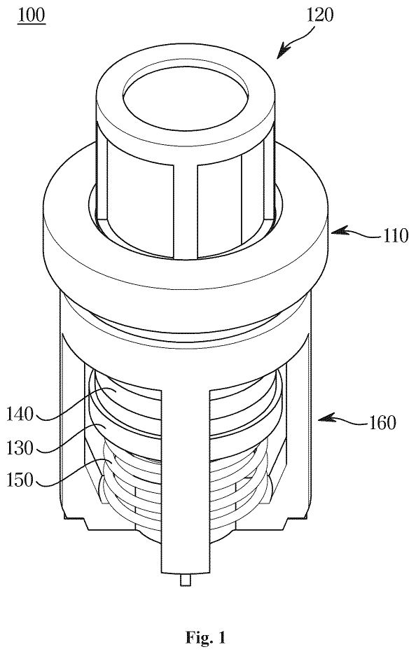

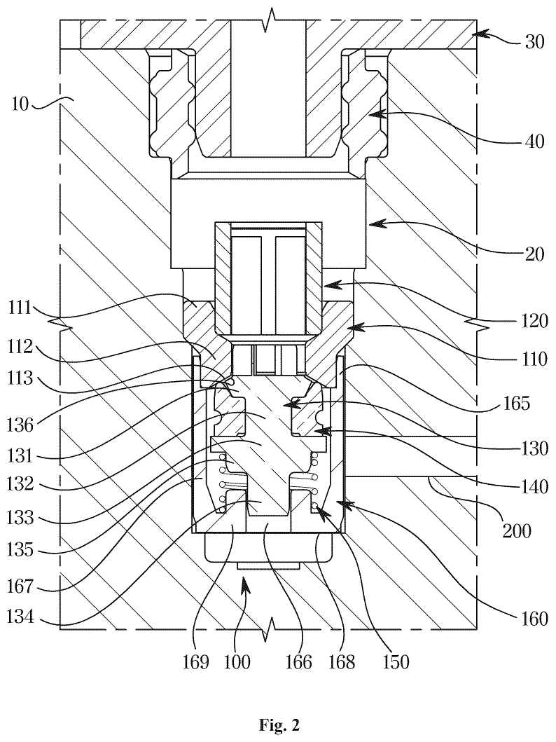

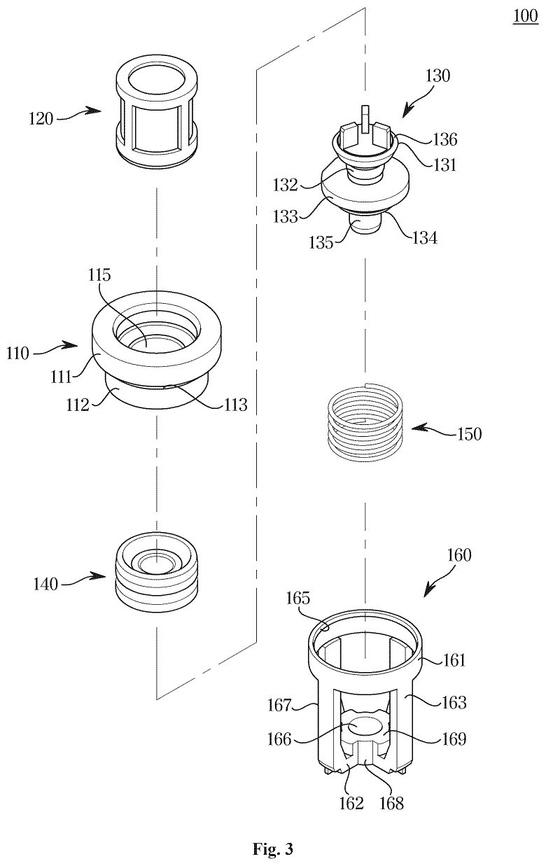

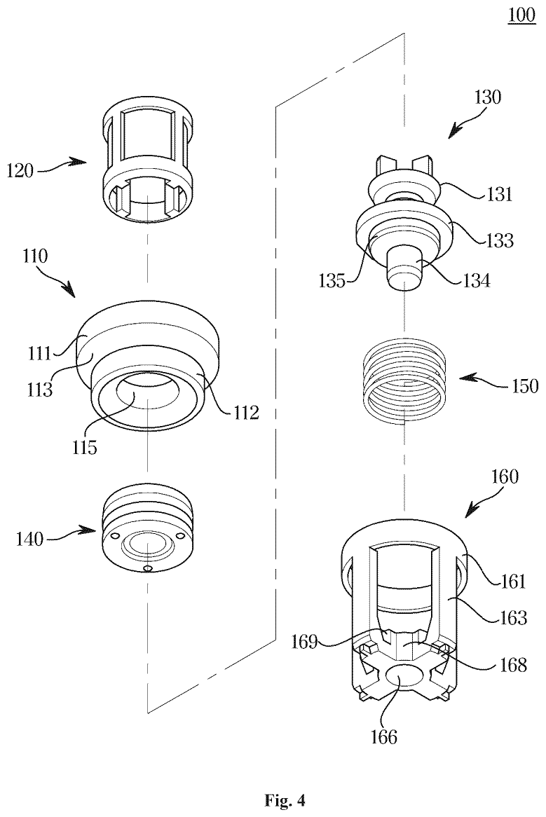

FIG. 1 is a perspective view of a check valve according to an exemplary embodiment of the present disclosure. FIG. 2 is a cross-sectional view illustrating a state in which the check valve according to an exemplary embodiment of the present disclosure is installed. FIG. 3 is an exploded perspective view of the check valve according to an exemplary embodiment of the present disclosure. FIG. 4 is an exploded perspective view of the check valve according to an exemplary embodiment of the present disclosure viewed from a different direction from FIG. 3. The check valve 100 determines a flow direction of fluid within a system in an integrated electric brake system. Here, the check valve 100 may serve to provide a flow passage from a reservoir to a pump, and conversely, block the fluid flow from the pump toward the reservoir. The check valve 100 in the integrated electric brake system requires a high flow rate due to characteristics of supplying a fluid to the pump, and is configured to be opened by a negative pressure generated by increasing a volume inside a chamber as the pump moves.

Due to these functional requirements, the closer the check valve 100 is to the reservoir or pump physically, the less the flow passage resistance is, which is advantageous in terms of performance. Considering a bore formed in a block to which a check valve pump is assembled, the structure may be advantageous in terms of performance as the resistance to the fluid flow is lower.

Referring to FIG. 2, the check valve 100 is installed in a bore 20 formed in a block 10 and may control a flow direction of fluid supplied from a reservoir 30. Since a strong hydraulic pressure is applied to an outlet 31 of the reservoir 30, a grommet 40 may be installed to protect the outlet 31.

The check valve 100 may include a sheet 110 that is press-fitted into an inner diameter of the bore 20, a filter 120 that is seated on an upper side of the sheet 110 and through which the fluid passes, a plunger 130 that is disposed on a lower side of the sheet 110 to open and close the sheet 110, a seal 140 that is installed to surround the plunger 130, a spring 150 that provides a restoring force to the plunger 130, and a housing160 that is assembled to the sheet 110 and guides a vertical movement of the plunger 130.

Referring to FIG. 1, the check valve 100 may be provided in the form of a single assembly and installed in the bore 20. The housing 160 may be assembled to a lower portion of the sheet 110, and a space formed by the sheet 110 and the housing 160 may accommodate the plunger 130 and the spring 150.

The check valve of the existing integrated electric brake system has a structure in which it is installed in a separate bore different from the bore in which the reservoir is installed, and the flow passage from the reservoir is connected to a separate bore and then connected to a pump chamber again. This not only increases the fluid resistance, but also requires the separate bore and flow passage processing, which causes an increase in manufacturing cost. In contrast, the check valve 100 illustrated in FIG. 2 is installed on the same bore 20 in which the reservoir 30 is installed, and thus may have a structure that minimizes the fluid resistance.

Referring to FIGS. 1 to 4, the sheet 110 may include a large outer diameter portion 111 that directly communicates with the reservoir 30, and a small outer diameter portion 112 that has a diameter smaller than the large outer diameter portion 111. Referring to FIG. 2, the sheet 110 may have a cross-section that is generally in the shape of a ‘V’ in which a radius of an opening 115 becomes narrower from the upper side to the lower side, and may have a shape that provides a path for collecting the fluid downward.

In the assembled state of the check valve 100, the large outer diameter portion 111 is press-fitted into the inner diameter of the bore 20, so the fluid does not flow into a gap between the large outer diameter portion 111 and the inner diameter of the bore 20, and the sealing may be omitted for this portion.

The filter 120 may be seated by contacting an inner diameter of the large outer diameter portion 111. When the fluid flows in toward the sheet 110, it may not be directly injected into the opening 115, but may pass through the filter 120. Since the fluid first passes through the filter 120, after passing through the opening 115, the fluid may quickly pass through the housing 160 without the loss of flow rate and be discharged into a discharge flow passage 200.

The small outer diameter portion 112 may be coupled to an upper portion 165 of the housing 160. For example, an outer diameter of the small outer diameter portion 112 may be formed with a screw thread, and an inner diameter of the upper portion 165 may be formed with a screw thread engaged therewith. In this way, when the sheet 110 and the housing 160 are firmly coupled, the seal 140 may properly perform a sealing function.

The plunger 130 may include an upper portion 131 that contacts the sheet 110, a middle portion 132 that seats the seal 140, a lower portion 133 that supports a lower side of the seal 140, and a rod 134 that penetrates through a lower portion of the housing 160. The upper portion 131 may have a shape that extends more radially than the middle portion 132, and the lower portion 133 may have a shape that extends more radially than the upper portion 131. The seal 140 may be disposed in a space formed between the upper portion 131 and the lower portion 133 based on an axial direction. An upper surface of the lower portion 133 may support a lower portion of the seal 140.

The housing 160 may include a ring-shaped upper plate 161 that is coupled to a lower end of the sheet 110, a lower plate 162 that is spaced apart from the upper plate 161 by a predetermined distance and formed with a first outlet 167, and a plurality of connecting rods 163 connecting the upper plate 161 and the lower plate 162. The fluid may be discharged downward through the first outlet 167 or may be discharged in a radial direction through a second outlet 168 formed between the plurality of connecting rods 163.

The spring 150 may be disposed between the lower portion 133 of the plunger 130 and the lower portion of the housing 160, i.e., the lower plate 162. The spring 150 constantly provides a pushing force to the plunger 130 to maintain the contact state between the plunger 130 and the sheet 110. However, when the fluid flows through the sheet 110, a strong hydraulic pressure is applied to the plunger 130, so a gap occurs between the sheet 110 and the plunger 130.

An opening 166 may be formed in the lower portion of the housing 160, i.e., the lower plate 162, so that the rod 134 of the plunger 130 may pass therethrough, and a guide part 169 may be formed to surround an outer diameter of the rod 134 and guide the rod 134. The guide part 169 may have a shape extending upward from the lower plate 162, and the opening 166 is formed at the center of the guide part 169.

A locking jaw 135 may be formed below the lower portion 133 of the plunger 130. An upper end of the spring 150 may be fitted into the locking jaw 135, and a lower end of the spring 150 may be fitted into the guide part 169. In order for the spring 150 to smoothly apply the restoring force, an outer diameter of the locking jaw 135 may have a size that is almost the same as that of the guide part 169. Meanwhile, the inner diameter of the spring 150 may have a size that is slightly larger than the outer diameter of the locking jaw 135 or the guide part 169.

A first inclined surface 113 inclined downwardly may be formed on the lower portion of the sheet 110, i.e., the small outer diameter portion 112, and a second inclined surface 136 inclined to correspond to the first inclined surface 113 may be formed on the upper portion 131 of the plunger 130. When the fluid refluxes and the plunger 130 rises, the second inclined surface 136 of the plunger 130 may be in close contact with the first inclined surface 113 of the sheet 110 to block the flow of the fluid into the reservoir 30.

Referring to FIG. 2, the angle at which the first inclined surface 113 and the second inclined surface 136 are inclined may be, for example, between 30° and 60°. When the lower portion of the sheet and the upper portion of the plunger have flat surfaces parallel to the radial direction, it is difficult for the sealing action of the seal 140 to occur reliably, so it is necessary to form the inclined surface as in the exemplary embodiment.

The seal 140 may be disposed to surround the outer diameters of the upper portion 131 and the middle portion 132 of the plunger 130 so as to seal between the lower surface of the sheet 110, that is, the first inclined surface 113 and the upper surface of the plunger 130, that is, the second inclined surface 136. Since the sheet 110 and the plunger 130 are made of a hard metal material or a plastic material, even if the sheet 110 and the plunger 130 come into contact with each other, it may be difficult to achieve the complete sealing therebetween, so the seal 140 made of an elastic material may secure the performance of this sealing action.

A protrusion 137 extending into the inside of the sheet 110 may be formed on the upper portion 131 of the plunger 130. The protrusion 137 may extend beyond the small outer diameter portion 111 of the sheet 110 to the large outer diameter portion 112, and the tip of the protrusion 137 may be positioned inside the filter 120.

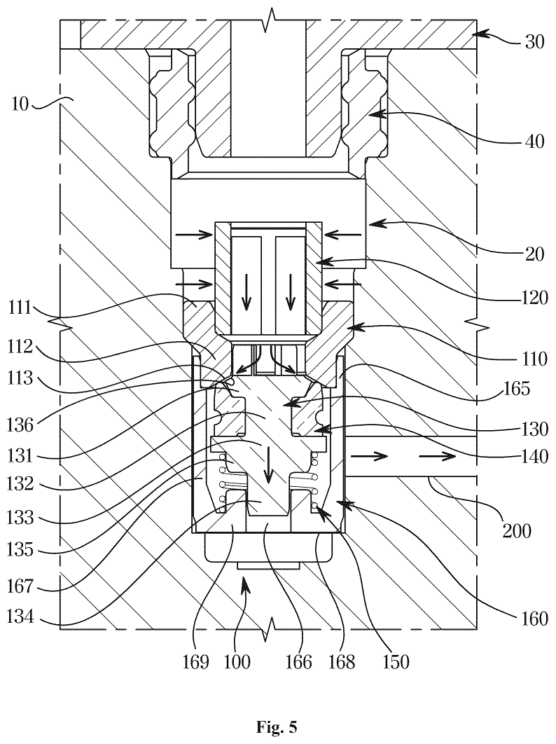

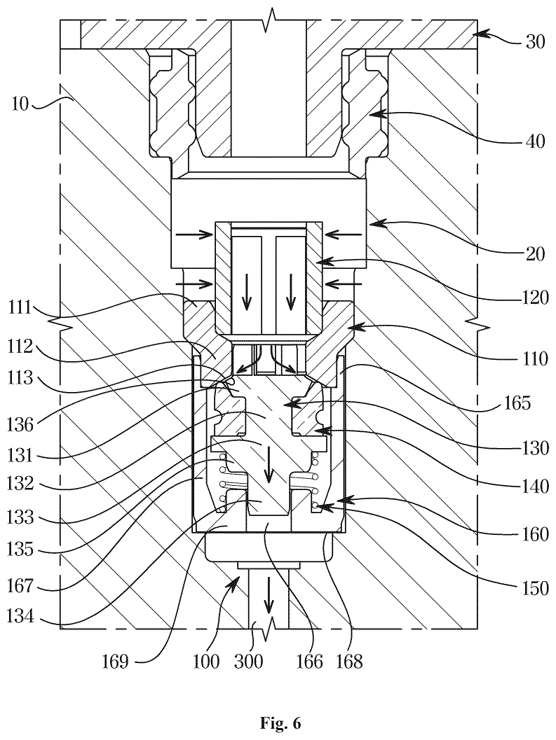

FIG. 5 is a cross-sectional view illustrating an example in which a radial flow passage is formed in a block in FIG. 2. FIG. 6 is a cross-sectional view illustrating an example in which an axial flow passage is formed in a block in FIG. 2.

When the hydraulic pressure is generated in the brake system and the fluid flows in from the reservoir 30, the fluid may pass through the grommet 40 installed in the outlet 31 of the reservoir 30 that accommodates the fluid 30, then pass through the filter 120, and then flow into the sheet 110.

In this case, the plunger 130 may be lowered to form the space between the lower portion of the sheet 110 and the upper portion of the plunger 130. When the fluid flows into the space, the fluid may be discharged radially to the discharge flow passage 200 through the second outlet 168 formed between the plurality of connecting rods 163 of the housing 160 as illustrated in FIG. 5, or may be discharged axially into a discharge flow passage 300 through the first outlet 167 formed in the lower plate 162 of the housing 160 as illustrated in FIG. 6.

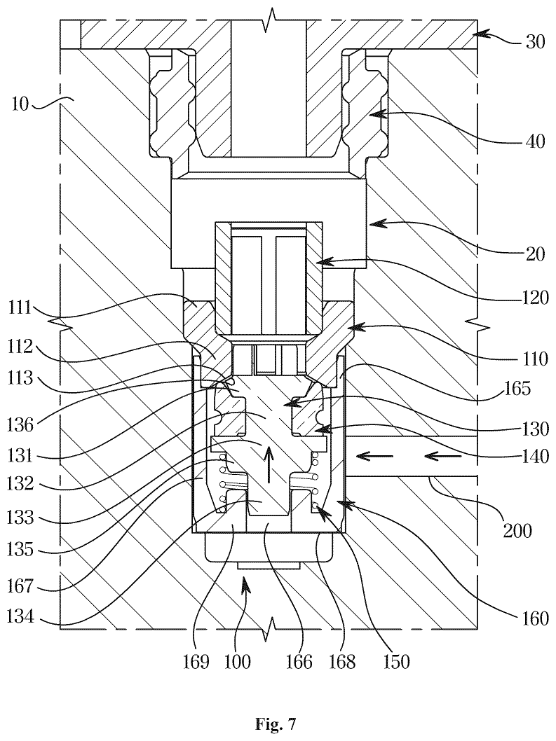

FIG. 7 is a cross-sectional view illustrating an example in which the check valve blocks a reflux in a state illustrated in FIG. 5.

When the reflux occurs from the radial discharge flow passage 200, the fluid passes through the second outlet 168 formed between the plurality of connecting rods 163 and flows toward the plunger 130, and the plunger 130 rises by the hydraulic pressure. In this case, the seal 140 installed on the outer diameter of the plunger 130 may seal between the sheet 110 and the plunger 130 while coming into contact with the lower surface of the sheet 110. In this case, the fluid may not pass through the sheet 110, and the seal 140 may prevent the fluid from refluxing into the reservoir 30.

FIGS. 5 to 7 illustrate the exemplary embodiment in which the discharge flow passage is formed in one of the radial or axial directions, but the exemplary embodiment is not limited thereto, and an exemplary embodiment in which the discharge flow passage is formed in both the radial and axial directions is also possible.

The check valve according to the exemplary embodiment is mounted directly on the lower end of the reservoir, so there is no need for the separate bore space for installing the check valve, and the fluid resistance may be minimized during passing through the check valve in the reservoir.

Since the check valve according to the exemplary embodiment has the sheet installed directly in the bore, the check valve does not require components such as a separate cap, does not require additional sealing from the outside, and has a sub-assembly structure, thereby minimizing the assembly work.

The check valve according to the exemplary embodiment is an open type that utilizes the inner shape of the bore as the flow passage, and may be structured to maximize the fluid flow area.

Hereinabove, although the present disclosure has been described with reference to an exemplary embodiment illustrated in the drawings, it is only an example, and it will be understood by those skilled in the art that various modifications and other equivalent exemplary embodiments are possible from the present disclosure. Therefore, the scope of the present disclosure is to be defined by the claims.

1. A check valve installed in a bore formed in a block and controlling a flow direction of a fluid supplied from a reservoir, the check valve comprising:
a sheet that is press-fitted into an inner diameter of the bore;
a filter that is seated on an upper side of the sheet and through which the fluid passes;
a plunger that is disposed on a lower side of the sheet to open and close the sheet;
a seal that is installed to surround the plunger;
a spring that provides a restoring force to the plunger; and
a housing that is assembled to the sheet and guides a vertical movement of the plunger.

2. The check valve of claim 1, wherein the sheet includes:
a large outer diameter portion that directly communicates with the reservoir; and
a small outer diameter portion that has a diameter smaller than the large outer diameter portion.

3. The check valve of claim 2, wherein the filter is seated by contacting an inner diameter of the outer diameter portion.

4. The check valve of claim 2, wherein the small outer diameter portion is coupled to an upper portion of the housing.

5. The check valve of claim 1, wherein the plunger includes:
an upper portion that contacts the sheet;
a middle portion that seats the seal;
a lower portion that supports a lower side of the seal; and
a rod that penetrates through a lower portion of the housing.

6. The check valve of claim 5, wherein the spring is disposed between the lower portion of the plunger and the lower portion of the housing.

7. The check valve of claim 5, wherein the lower portion of the housing is formed with an opening so that the rod passes therethrough, and a guide part that is formed to surround an outer diameter of the rod and guides the rod.

8. The check valve of claim 1, wherein a lower portion of the sheet is provided with a first inclined surface inclined downward, and
an upper portion of the plunger is provided with a second inclined surface inclined to correspond to the first inclined surface.

9. The check valve of claim 8, wherein when the plunger rises, the second inclined surface of the plunger comes into close contact with the first inclined surface of the sheet to block a flow of the fluid into the reservoir.

10. The check valve of claim 1, wherein an upper portion of the plunger is formed with a protrusion extending into an inside of the sheet.

11. The check valve of claim 5, wherein the plunger has a locking jaw formed below the lower portion.

12. The check valve of claim 11, wherein the spring is disposed between the lower portion of the plunger and the lower portion of the housing, and an inner diameter is formed to be larger than an outer diameter of the locking jaw so that the upper portion is fitted into the locking jaw.

13. The check valve of claim 11, wherein the lower portion of the housing is formed with a guide part that is formed to surround an outer diameter of the rod and guide the rod, and
the locking jaw is formed to have a size of an outer diameter similar to that of the outer diameter of the guide part.

14. The check valve of claim 1, wherein the sheet is screwed to the housing.

15. The check valve of claim 14, wherein the sheet includes:
a large outer diameter portion that directly communicates with the reservoir; and
a small outer diameter portion that has a diameter smaller than the large outer diameter portion,
the small outer diameter portion has a screw thread formed on an outer diameter, and
an inner diameter of an upper portion of the housing has a screw thread formed to engage the screw thread.

16. A check valve, comprising:
a sheet that is installed in a bore formed in a block and into which a fluid flows from a reservoir;
a housing that is assembled to a lower portion of the sheet;
a filter that is seated on an upper portion of the sheet and through which the fluid passes;
a plunger that is disposed on a lower side of the sheet to open and close the sheet;
a seal that is installed to surround the plunger; and
a spring that provides a restoring force to the plunger.

17. The check valve of claim 16, wherein the fluid passes through a grommet installed at an outlet of the reservoir that accommodates the fluid, passes through the filter, and then flows into the sheet.

18. The check valve of claim 16, wherein when the fluid flows in from the reservoir, the plunger is lowered to form a space between the lower portion of the sheet and an upper portion of the plunger.

19. The check valve of claim 16, wherein the seal is disposed to surround an outer diameter of the plunger and seals between a lower surface of the sheet and an upper surface of the plunger.

20. The check valve of claim 16, wherein the housing includes:
a ring-shaped upper plate that is coupled to a lower end of the sheet;
a lower plate that is spaced apart from the upper plate by a predetermined distance and has an opening formed therein; and
a plurality of connecting rods that connects the upper plate and the lower plate.
